(19) United States
(12) Patent Application Publication
(10) Pub. No.: US 2026/0303888 A1
(43) Pub. Date: Oct. 1, 2026

(54) REPORTING PRESENTATION LATENCY DATA FOR MEDIA STREAMING

(71) Applicant: QUALCOMM Incorporated, San Diego, CA (US)

(72) Inventors: Thomas Stockhammer, Bergen (DE); Imed Bouazizi, Celina, TX (US); Aytac Biber, Carlsbad, CA (US); Liangping Ma, San Diego, CA (US)

(21) Appl. No.: 19/575,733

(22) Filed: Mar. 23, 2026

Related U.S. Application Data
(60) Provisional application No. 63/777,391, filed on Mar. 25, 2025.

(51) Int. Cl. H04N 21/24; H04L 67/02; H04N 21/242

(52) U.S. Cl. CPC H04N 21/2407; H04L 67/02; H04N 21/242

(57) ABSTRACT

An example method includes synchronizing, by a media client, a media client time with a network function time of a network; receiving, by the media client, a producer reference time for a media segment of a media presentation; measuring, by the media client, presentation latency of media data included in the media segment using the producer reference time; and reporting, by the media client, the measured presentation latency of the media data. Another example method includes synchronizing a media client time of a media client with a network function time of a network; sending a producer reference time for a media segment of a media presentation to the media client; and receiving presentation latency measurement data for media data included in the media segment from the media client.

This application claims the benefit of U.S. Provisional Application No. 63/777,391, filed Mar. 25, 2025, the entire contents of which are hereby incorporated by reference.

### TECHNICAL FIELD

This disclosure relates to storage and transport of encoded video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for reporting, and receiving reports regarding, measured presentation latency of streamed media data. A client device may receive a producer reference time for a media segment of a media presentation, receive the media segment, and measure a presentation latency for media data included in the media segment using the producer reference time. The client device may then report the presentation latency to a server device, which may use the presentation latency to improve streaming. For example, measures may be taken to reduce network latency (e.g., improvements to the network itself), content steering may be initiated to direct a different device to perform content distribution, or the like. In this manner, network latency may be reduced.

In one example, a method of retrieving media data includes: synchronizing, by a media client, a media client time with a network function time of a network; receiving, by the media client, a producer reference time for a media segment of a media presentation; measuring, by the media client, presentation latency of media data included in the media segment using the producer reference time; and reporting, by the media client, the measured presentation latency of the media data.

In another example, a media client device for retrieving media data includes: a memory configured to store media data; and a processing system implemented in circuitry and configured to: synchronize a media client time with a network function time of a network; receive a producer reference time for a media segment of a media presentation; measure presentation latency of media data included in the media segment using the producer reference time; and report the measured presentation latency of the media data.

In another example, a method of collecting presentation latency measurement data for sent media data includes: synchronizing a media client time of a media client with a network function time of a network; sending a producer reference time for a media segment of a media presentation to the media client; and receiving presentation latency measurement data for media data included in the media segment from the media client.

In another example, a media collection server device includes: a memory configured to store media data; and a processing system implemented in circuitry and configured to: synchronize a media client time of a media client with a network function time of a network; send a producer reference time for a media segment of a media presentation to the media client; and receive presentation latency measurement data for media data included in the media segment from the media client.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating elements of an example video file.

FIG. 3 is a graph illustrating heuristic testing of delivery of audio segments of media data.

FIG. 4 is a block diagram illustrating an example of a basic media streaming architecture per techniques of this disclosure.

FIG. 5 is a block diagram illustrating an example 5G Media Streaming architecture per techniques of this disclosure.

FIG. 6 is a block diagram illustrating an example set of components of a media session handler (MSH) per techniques of this disclosure.

FIG. 7 is a block diagram illustrating an example media stream handler per techniques of this disclosure.

FIG. 8 is a block diagram illustrating an example set of network devices that may participate in latency metric reception per techniques of this disclosure.

FIGS. 9 and 10 are flow diagrams illustrating an example process for establishing a media communication session including latency metric reporting according to techniques of this disclosure.

FIG. 11 is a flow diagram illustrating an example process for sending media data and reporting latency metrics per techniques of this disclosure.

FIG. 12 is a flowchart illustrating an example method of collecting presentation latency measurement data for a media communication session according to techniques of this disclosure.

FIG. 13 is a flowchart illustrating an example method of measuring and reporting presentation latency of media data received during a media communication session according to techniques of this disclosure.

### DETAILED DESCRIPTION

Adaptive streaming systems, using protocols such as Dynamic Adaptive Streaming over HTTP (DASH) or HTTP Live Streaming (HLS), often prioritize low end-to-end latency to ensure synchronized playback and a high quality of experience. Service providers generally aim to control the latency between content production and display. However, verifying whether a target latency has been achieved and identifying reasons for deviations present challenges. Conventional mechanisms may not provide a standardized or efficient way for a client device to calculate presentation latency relative to a producer time and report this data back to the network for analysis.

The techniques of this disclosure describe mechanisms for measuring and reporting presentation latency. A media client synchronizes a media client time with a network function time. The media client receives a producer reference time associated with a media segment, such as a capture time or encoding time carried in a ProducerReferenceTime box or element. The media client calculates presentation latency for the media segment using the producer reference time and the synchronized clock. The media client then reports the measured presentation latency, or derived statistics such as deviation from a target, to a network entity.

Implementing these techniques may enable network devices to collect precise latency metrics from client devices. Network administrators or service providers may use the reported latency data to perform quality of experience (QoE) analysis, aggregate latency statistics across multiple users, or trigger network optimizations. For instance, if the reported latency exceeds a threshold, the network may initiate content steering to switch the media stream to a different delivery node, thereby potentially reducing latency and improving the viewing experience.

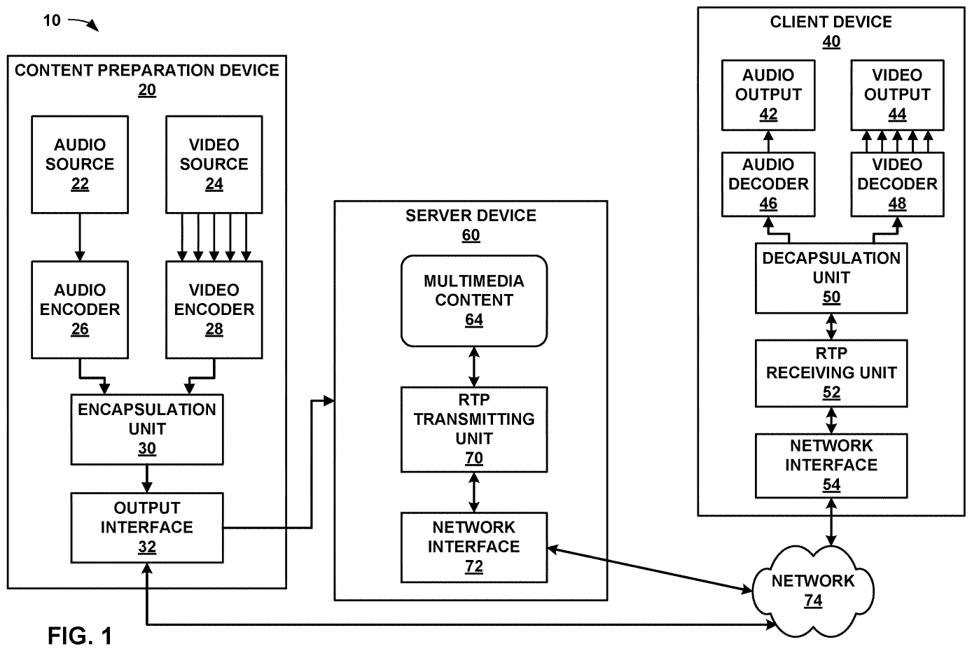

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of scalable video coding (SVC) and view scalability information SEI messages in multiview viedeo coding (MVC). These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement Uniform Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

In some examples, client device 40 functions as a media client that synchronizes a media client time with a network function time of a network. Client device 40 receives a producer reference time for a media segment of a media presentation and measures presentation latency of media data included in the media segment using the producer reference time. Client device 40 reports the measured presentation latency of the media data to server device 60. Server device 60 may function as a media collection server device that collects this presentation latency measurement data for sent media data. In this capacity, server device 60 sends the producer reference time for the media segment to client device 40 and receives the presentation latency measurement data.

By utilizing the specific arrangement of client device 40 and server device 60, the system may enable more accurate and actionable presentation latency monitoring compared to existing approaches. Specifically, because client device 40 synchronizes a media client time with the network function time and uses a specific producer reference time associated with the media segment, client device 40 can calculate a precise “glass-to-glass” or “encoder-to-glass” latency. Such measurement provides a more reliable indicator of the actual quality of experience (QoE) than estimating latency based solely on network throughput or buffer levels.

Furthermore, reporting this measured presentation latency to server device 60 allows for dynamic network optimizations that might not otherwise be possible. For example, if server device 60 receives reports indicating that latency targets are consistently missed, the system may trigger content steering to redirect client device 40 to a different distribution node or adjust quality of service (QoS) parameters to prioritize the media stream. Consequently, the techniques may lead to reduced end-to-end latency and a more consistent viewing experience for users.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

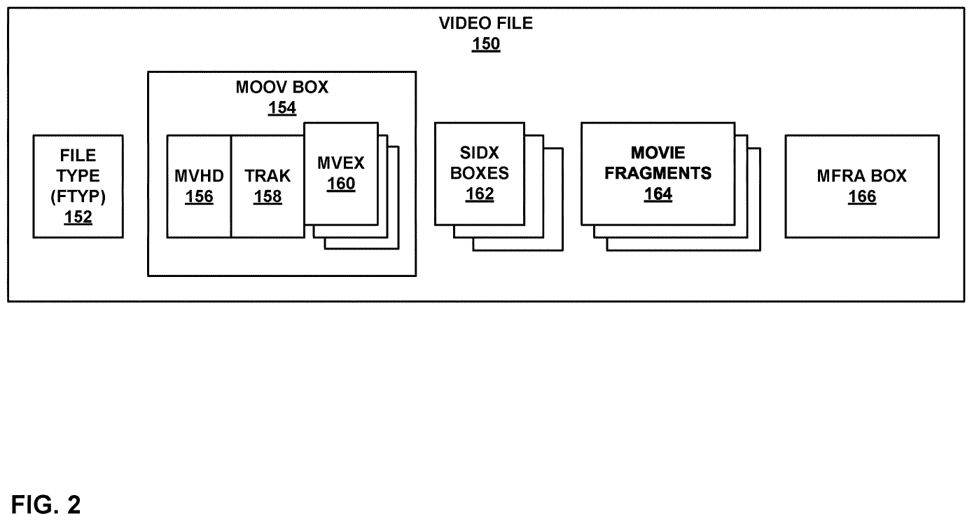

FIG. 2 is a block diagram illustrating elements of an example video file 150. As described above, video files in accordance with the ISO base media file format and extensions thereof store data in a series of objects, referred to as “boxes.” In the example of FIG. 2, video file 150 includes file type (FTYP) box 152, movie (MOOV) box 154, segment index (sidx) boxes 162, movie fragment (MOOF) boxes 164, and movie fragment random access (MFRA) box 166. Although FIG. 2 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

MOOV box 154, in the example of FIG. 2, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to Third Generation Partnership Project (3GPP) file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 2). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

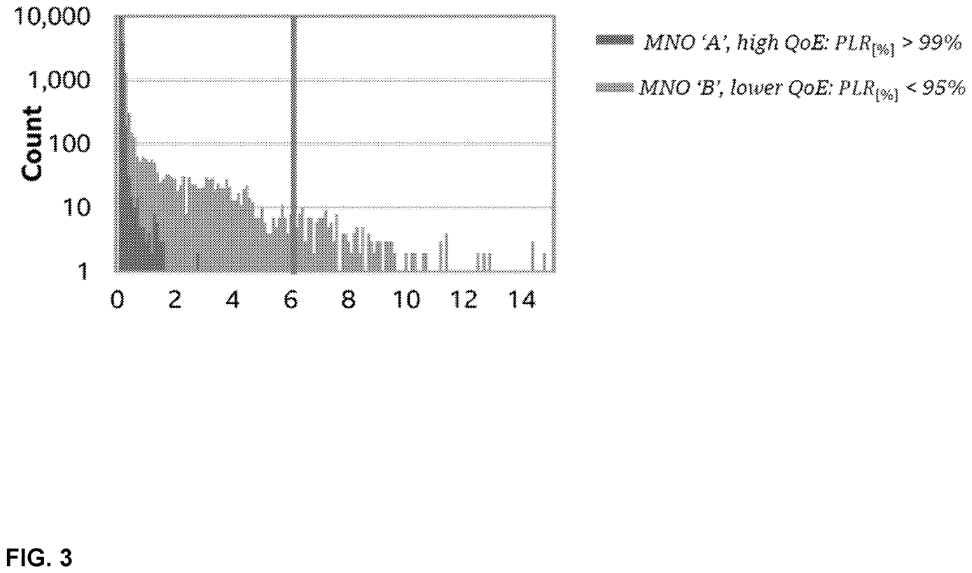

FIG. 3 is a graph illustrating heuristic testing of delivery of audio segments of media data. The graph depicts results of heuristic testing of times to deliver 6.4 second audio segments at 48 kbit/s. The graph is a histogram in a single 100m-by-100m pixel, 4G only, with two mobile network operators (MNOs).

In the example illustrated by FIG. 3, the histogram distinguishes between the performance of the two MNOs to highlight the impact of latency on user experience. A first operator, MNO ‘A’, demonstrates a high Quality of Experience (QoE) associated with a Packet Loss Rate (PLR) of greater than 99%. In contrast, a second operator, MNO ‘B’, demonstrates a lower QoE associated with a PLR of less than 95%. This distribution indicates that enabling a consistent experience, particularly by managing the latency of each audio segment, is an important concern for the delivery of audio and other media over mobile networks.

This disclosure recognizes that latency for delivery of audio segments is an important indicator of quality of service (QoS) for a user/listener. User equipment (UE) devices and other devices may be configured to measure segment latencies, e.g., using a streaming client application. This disclosure further recognizes that it may be beneficial for network devices (i.e., those in a streaming network, e.g., a radio access network (RAN)) to measure latency from the network side. This measured latency may be exposed via an application programming interface (API) in the network.

In an adaptive streaming environment using Media Segments (e.g., Common Media Application Format (CMAF) objects) and a manifest file (e.g., a media presentation description (MPD) of Dynamic Adaptive Streaming over HTTP (DASH) or a manifest of HTTP Live Streaming (HLS)), the service provider may attempt to control end-to-end latency. This may be beneficial to ensure synchronized playback across various streaming client devices. However, it may also be beneficial to measure the latency and report latency measurements back to the network or to the service provider.

Latency may be measured from “glass-to-glass,” e.g., for a live service, from the time at which a recording device records video data to the time at which a client device presents the video data via a screen. Additionally or alternatively, latency may be measured from “encoder to glass,” e.g., from the time at which an encoder encodes video data to the time at which a client device presents the video data via a screen.

Information representative of latency may include any or all of: what the actual latency is, if a desired target latency was met, deviation from the target latency, and/or reasons for the deviations from the target latency, e.g., late arrival, network issues, user controlled, or the like. The network and/or service provider may use such latency information to perform quality of experience (QoE) measurements for one or more client devices, perform network improvements if the target latency is not being met consistently (e.g., content steering, quality of service (QoS), or the like), and/or aggregate latency information across multiple users.

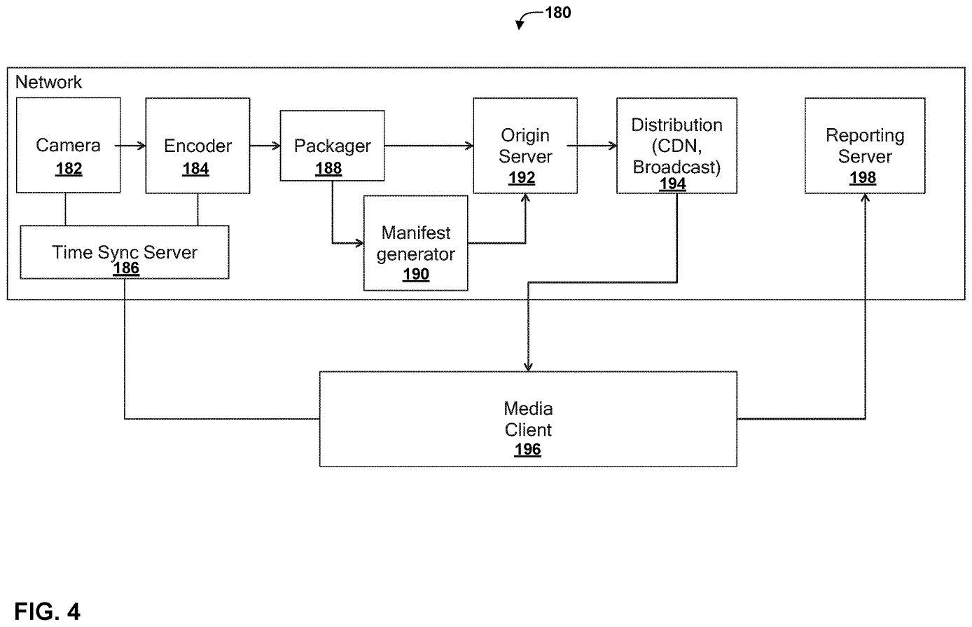

FIG. 4 is a block diagram illustrating an example of a basic media streaming architecture 180 per techniques of this disclosure. The example of FIG. 4 depicts camera 182, encoder 184, time synchronization (sync) server 186, packager 188, manifest generator 190, origin server 192, distribution devices 194, media client 196, and reporting server 198. In general, camera 182 may correspond to audio source 22 and video source 24 of FIG. 1, encoder 184 may correspond to audio encoder 26 and video encoder 28 of FIG. 1, packager 188 and manifest generator 190 may correspond to encapsulation unit 30 of FIG. 1, origin server 192 and distribution devices 194 may correspond to server device 60 of FIG. 1, and media client 196 may correspond to client device 40 of FIG. 1.

In addition, per techniques of this disclosure as discussed in greater detail below, time sync server 186 may be configured to measure latency of media data (e.g., audio and/or video data) sent to media client 196, and media client 196 may report various metrics, such as latency metrics, to reporting server 198.

In particular, an initial device for encoding and packaging media content (e.g., content preparation device 20 of FIG. 1 and/or a device or devices including encoder 184, packager 188, and/or manifest generator 190) may add producer reference frames to a manifest file and/or a producer reference time (“PRFT”) value to CMAF segments.

Time sync server 186 may synchronize a time between a client device (e.g., client device 40 of FIG. 1 or media client 196 of FIG. 4) and a server device (e.g., server device 60 and/or content preparation device 20 of FIG. 1, or a server device/system including any or all of encoder 184, packager 188, manifest generator 190, and/or time sync server 186 of FIG. 4). For example, time sync server 186 may use external means to synchronize the time, e.g., using coordinated universal time (UTC).

A service description may include data representing a desired latency.

Various devices of architecture 180 may then measure latency of segments delivered to media client 196 of FIG. 4. The latency measurements may include raw latency measurements and/or latency offset values (e.g., relative to a desired/target latency). Such latency measurements may be reported to network devices. For example, the latency measurements may be reported using DASH metrics and/or using Common Media Client Data (CMCD). The metrics may be reported in-band, i.e., as part of the media streaming session, or out-of-band, i.e., externally or separately from the media streaming session.

Network administrators of the core network and/or of the media producer may use such reports to perform various optimizations.

In some examples, latency measurements may be aggregated. That is, latency may be aggregated across the network, e.g., between various devices and/or from source to multiple client devices. APIs may be used to expose measured latencies.

By using the arrangement of time sync server 186 and the media processing chain (e.g., encoder 184 and packager 188), the system of FIG. 4 may enable precise measurement of presentation latency. Providing a common time reference via time sync server 186 allows media client 196 to accurately compare the presentation time of a media segment against a producer reference time. This configuration facilitates the calculation of end-to-end latency (e.g., glass-to-glass or encoder-to-glass) independent of local clock drifts or estimation errors.

Furthermore, reporting the measured presentation latency to reporting server 198 enables the system to dynamically improve delivery. For example, if reporting server 198 identifies that latency targets are not being met based on the received metrics, the system may trigger remedial actions such as content steering to a different distribution node 194 or adjustment of quality of service parameters. Consequently, the architecture supports maintaining low-latency streaming requirements and may enhance the overall consistency of the media service.

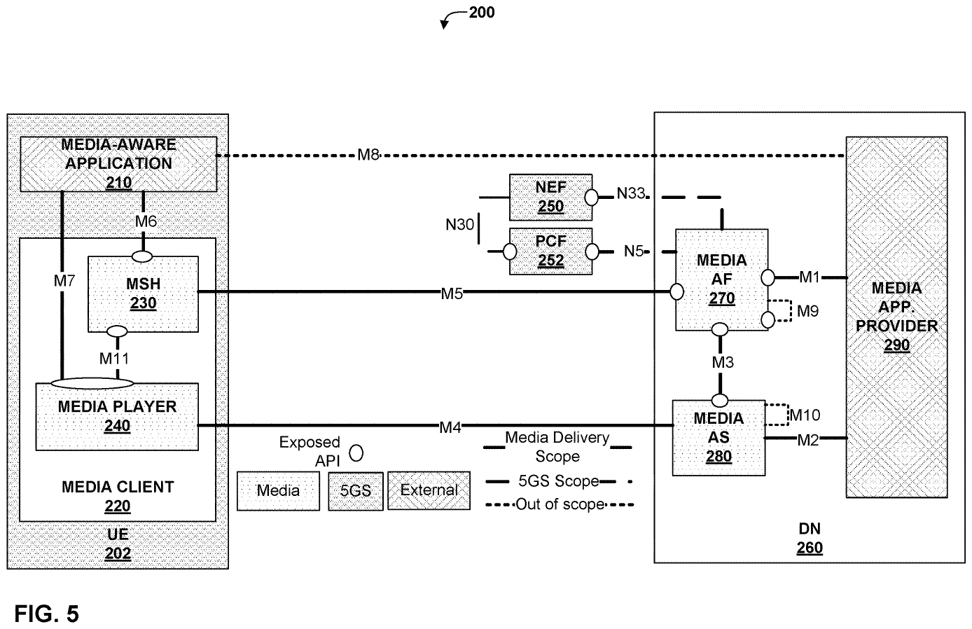

FIG. 5 is a block diagram illustrating an example 5G Media Streaming architecture 200 per techniques of this disclosure. In this example, architecture 200 includes user equipment (UE) device 202, data network (DN) system 260, network exposure function (NEF) device 250, and policy and charging function (PCF) device 252. UE device 202 includes media-aware application (210) (which may also be referred to as a 5GMSd-aware application) and media client 220 (which may also be referred to as a 5GMSd client). Media client 220 includes media session handler (MSH) 230 and media player 240. DN system 260 includes media application function (AF) device 270, media application server (AS) 280, and media application provider 290.

In the example of FIG. 5, media client 220 may synchronize a local media client time with a network function time provided by DN system 260. Media client 220 may receive a producer reference time for a media segment from DN system 260, measure presentation latency of media data in the segment using the producer reference time, and report the measured presentation latency back to DN system 260 (e.g., to media application function 270 or media application server 280).

NEF 250 may implement techniques for securely exposing services and capabilities provided by 3GPP network functions to external applications, such as media application provider 290. PCF 252 may govern network behavior, including providing policy rules to control plane functions, which may include Quality of Service (QoS) adjustments in response to reported latency deviations.

To facilitate the operations described above, NEF 250 and PCF 252 may use specific services or application programming interfaces (APIs). For example, NEF 250 may expose services such as Nnef_AFSessionWithQoS, Nnef_ChargeableParty, and Nnef_BDTPNegotiation. Similarly, PCF 252 may utilize services including Npcf_PolicyAuthorization and Npcf_BDTPolicyControl. Within the media delivery scope of DN system 260, media application function 270 may support Maf_Provisioning and Maf_SessionHandling, while media application server 280 may utilize Mas_Configuration for configuration purposes. These services may collectively enable the precise monitoring and management of presentation latency across the 5G system.

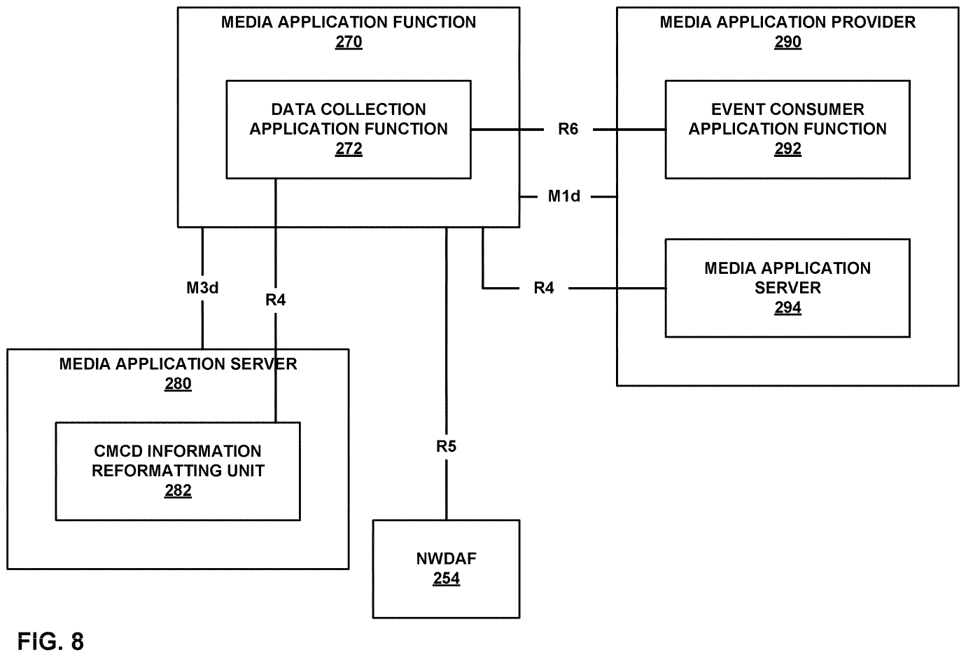

Although not shown in FIG. 5, architecture 200 may further include a network data analytics function (NWDAF), e.g., as shown in FIG. 8 below. The NWDAF may be configured to collect data from other network functions and provide analytics-based insights. In particular, the NWDAF may receive Common Media Client Data (CMCD) event exposure information from media AF device 270 via an R5 interface. This may allow the NWDAF to perform aggregation and generate observed latency reports that are exposed via an API, such as a CAMARA API, to media application provider 290.

Media AF device 270 may further include a data collection AF that acts as a centralized point for receiving reformatted CMCD information from media application server 280. Media application server 280 may use a CMCD information formatting unit to process raw latency reports received from UE device 202 into a format compatible with the data collection AF or the event consumer AF within media application provider 290.

In this example, UE device 202 retrieves media data from DN system 260, e.g., via DASH, HLS, or other media streaming protocols. Media player 240 and MSH 230 generally communicate with DN system 260 to establish a streaming session and to retrieve media data via the streaming session.

Per techniques of this disclosure, media client 220 may be time-synchronized to a network function of DN system 260 that generates a producer reference time and that signals this producer reference time in media data sent to media client 220. Media client 220 may then use the producer reference time in the media to measure latency, and then report measured/observed latency of a media sample or derived information back to DN system 260. The producer reference time may be a {media time, wall clock time} pair, where media time relates to wall-clock time.

Media client 220 may perform latency measurements as follows. Media client 220 may use information documented in the producer reference time as an anchor. Media time of the anchor may be referred to as “MTA,” and wall-clock time of the anchor may be referred to as “WCA.” Media client 220 may determine a timescale that documents units per second as “TS.” Media client 220 may then calculate a media time latency (MTL) of a media time (MT) presented at a wall clock time (WC) in seconds according to MTL=(WC−WCA)−(PT−PTA)/TS.

As an example, let the timescale (TS) be set to 20. Assume the media time of a sample is 3740 and the presentation time for the sample is at 20:18:10.5, and the anchor of the wall-clock time is 20:15:00. Then the presentation latency of the sample is derived as 190.5s−3740/20s=190.5s−187s=3.5s.

In some examples, media client 220 may be time-synchronized to a network function of DN system 260 that generates a producer reference time and signals this producer reference time in media data sent to media client 220. Media client 220 may then use the producer reference time information in received media data to measure latency for the media data, and media client 220 may report the measured/observed latency for a media sample or derived latency information back to the network, e.g., DN system 260.

Media client 220 may be a DASH client, an HLS client, or any media client that consumes CMAF segments or similar data objects for media data.

The producer reference time may be a capture time of the media sample, the encoding time of the media sample, or any other relevant time for the network provider.

Time synchronization may be accomplished using UTC time synchronization, e.g., per DASH, using a network clock, and/or using a general system clock.

The producer time may be carried in any or all of a manifest file for the media presentation, segments of the media presentation, CMAF segments (e.g., using a producer reference time (PRFT) box), a DASH MPD in a ProducerTimeReference element, or implicitly document in availability times signaled in the manifest file.

Media client 220 may send reports representing the measured latencies as part of DASH metrics, as CMCD keys, and/or as QoE metrics in 3GPP. Media client 220 may send the reports in-band (e.g., as HTTP headers or query parameters) and/or to a dedicated server during or after the media streaming session.

A media sample for which media client 220 reports measured latency may be the start of a specific segment, the start of a previous segment, any media time that is configured in measurement configurations (e.g., every 10 seconds), or only measured based on events, e.g., the latency exceeding a threshold.

In some examples, media client 220 may measure not just the latency but elements of derived information for the latency, such as, if a presentation latency is configured (for example via a service description), then deviations from the presentation latency may be measured; media client 220 may aggregate latency measurements and report a distribution of the latency measurements; media client 220 may initiate latency measurement reporting only if a specific event occurs; and/or reporting may depend on a playback mode of a client (e.g., reporting in live mode but not in timeshift mode).

The network may be a generic Internet/cloud-based distribution, a 3GPP network, a radio access network (RAN) such as a 5G Media Streaming network (e.g., including an application server (AS)), and/or a broadcast network such as a 5G Broadcast or ATSC3.0 network using CMAF segments.

The network reporting server may be a generic reporting server; a 5GMS AS, a 5GMS AF, and/or a data collection AF (which may trigger network actions in the network if reported latency is not aligned with target latency); a reporting server connected to a content steering server (such that client devices may be steered to different networks if latency for a particular network is not appropriate); and/or a network function, such as the AF that exposes the latency metrics via an API, such as CAMARA.

Architecture 200 may perform the various techniques of this disclosure to facilitate precise and standardized presentation latency reporting that leverages 5G network capabilities. For example, because media client 220 interacts with DN system 260 via defined interfaces, system 200 can facilitate reporting of latency measurements in a format that is immediately actionable by network functions. This integration may enable the 5G system to dynamically adjust quality of service (QoS) policies via the policy and charging function (PCF) 252 or trigger network-assisted content steering if the measured presentation latency exceeds acceptable thresholds, thereby optimizing the delivery of media services over the 5G network.

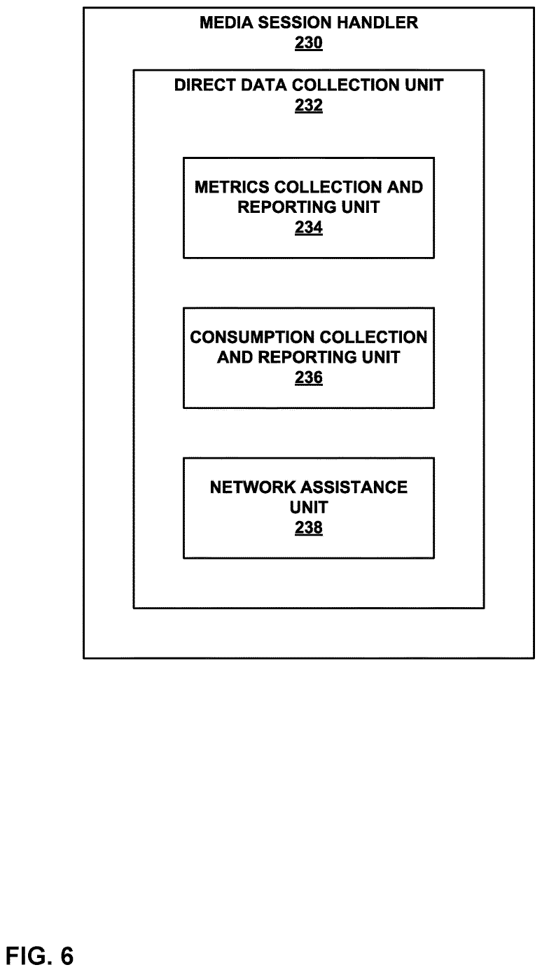

FIG. 6 is a block diagram illustrating an example set of components of MSH 230 of FIG. 5 per techniques of this disclosure. In this example, MSH 230 includes direct data collection unit 232, which further includes metrics collection and reporting unit 234, consumption collection and reporting unit 236, and network assistance unit 238. In general, metrics collection and reporting unit 234 may report metrics, such as latency measurements, per techniques of this disclosure to a reporting server. Consumption collection and reporting unit 236 may report consumption of media data of a particular media presentation (e.g., which segments were requested and received). Network assistance unit 238 may be configured to request streaming from a different server if latency is too high for a particular media presentation.

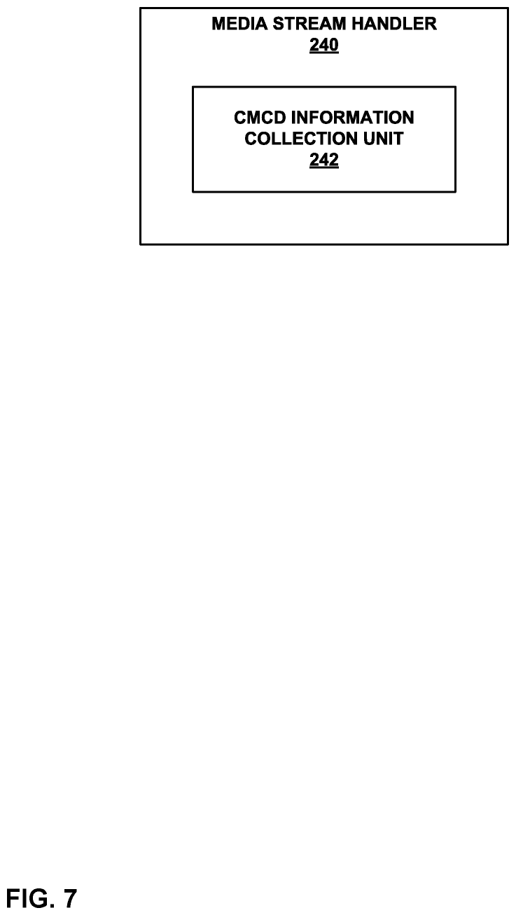

FIG. 7 is a block diagram illustrating an example media stream handler 240 per techniques of this disclosure. Media stream handler 240 may be included in media client 220 of FIG. 5, and may be communicatively coupled to MSH 230 via an M11d interface (for CMCD information collection configuration). In this example, media stream handler 240 includes CMCD information collection unit 242, which may perform in-band CMCD reporting to a 5GMS AS, e.g., as discussed in greater detail with respect to FIG. 8 below.

FIG. 8 is a block diagram illustrating an example set of network devices that may participate in latency metric reception per techniques of this disclosure. In this example, FIG. 8 depicts media application server (AS) 280 (which may also be referred to as a “5GMS AS”), media application function 270 (which may also be referred to as a “5GMS AF”), network data analytics function (NWDAF) 254, and media application provider 290 (which may also be referred to as a “5GMS AP”).

Media application server 280 includes CMCD information reformatting unit 282. CMCD information reformatting unit 282 may receive latency reports from a client device (e.g., CMCD information collection unit 242 of FIG. 7), reformat the latency reports into a format usable by media application function 270 and/or media application provider 290, and send the reformatted latency reports to data collection application function 272 of media application function 270.

Media application function 270 may send client reporting configuration information to, e.g., MSH 230 of FIG. 5, via an M5d interface.

NWDAF 254 and media application function 270 may exchange CMCD event exposure information via an R5 interface.

Media application provider 290, in this example, includes event consumer application function 292 and media application server 294. Event consumer application function 292 may send CMCD event exposure information to data collection application function 272 via an R6 interface. Media application server 294 may send media data to data collection application function 272 via an R4 interface. Media application provider 290 may exchange CMCD reportion provisioning and CMCD event exposure provisioning with media application function 270 via an M1d interface.

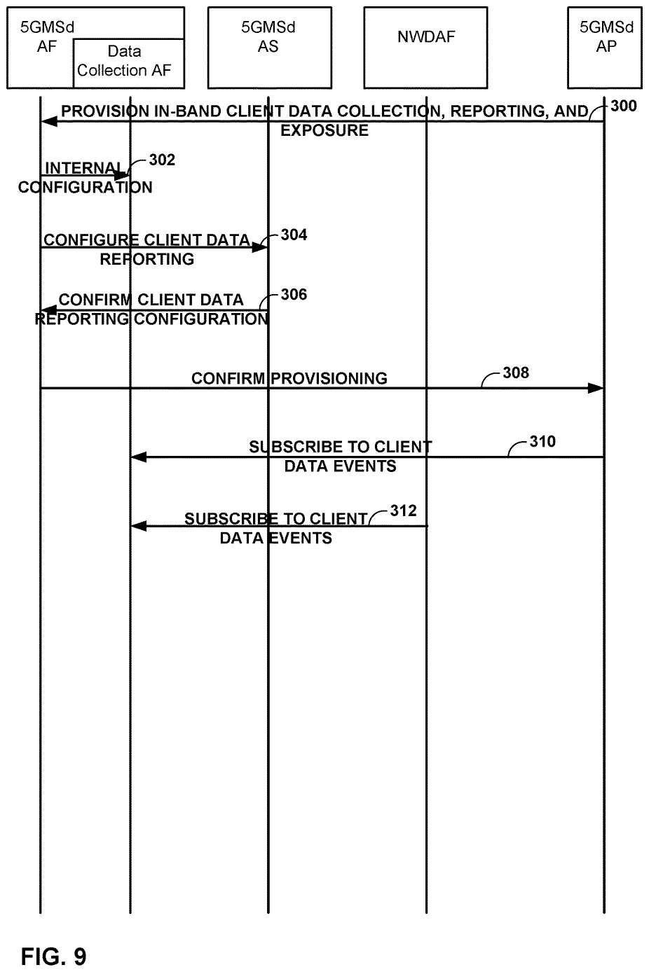

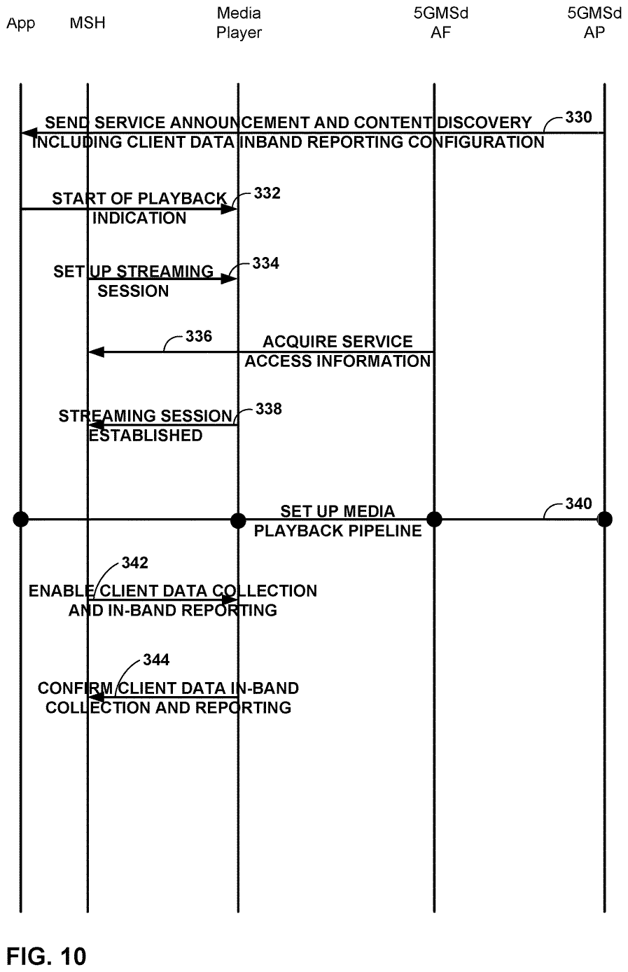

FIGS. 9 and 10 are flow diagrams illustrating an example process for establishing a media communication session including latency metric reporting according to techniques of this disclosure.

FIG. 9 illustrates an example process for provisioning in-band client data collection, reporting, and exposure. This process generally involves media application provider 290 (e.g., a 5GMS Application Provider), media AF device 270 (e.g., a 5GMS AF), media application server 280 (e.g., a 5GMS AS), and network data analytics function (NWDAF) 254.

Media application provider 290 sends a request to provision in-band client data collection, reporting, and exposure to media application function 270 (300). Media application provider 290 may send this request via an M1d interface. The request may specify the metrics to collect, such as presentation latency, and the reporting rules (e.g., report frequency, reporting events, and the like). Media application function 270 performs internal configuration of a data collection AF based on the received request (302). Media application function 270 then sends a configuration message to media application server 280 to configure client data reporting (304). This configuration instructs media application server 280 on how to handle incoming metric reports from client devices, such as extracting latency metrics from in-band data (e.g., HTTP headers).

Media application server 280 sends a confirmation of the client data reporting configuration to media application function 270 (306). Subsequently, media application function 270 sends a confirmation of the provisioning to media application provider 290 (308). Once configured, data consumers may subscribe to the generated data. For instance, media application provider 290 may send a subscription request to media application function 270 to subscribe to client data events (310). Additionally or alternatively, NWDAF 254 may send a subscription request to media application function 270 to subscribe to client data events (312) Media application function 270 may expose the collected latency metrics to media application provider 290 and/or NWDAF 254 for network analytics.

FIG. 10 illustrates an example process for establishing a media communication session including latency metric reporting. This process involves media-aware application 210, media session handler 230, media player 240, media application function 270, and media application provider 290.

Media application provider 290 sends a service announcement and content discovery information to media-aware application 210 (330). The service announcement includes client data in-band reporting configuration information. This configuration information may specify parameters for collecting and reporting presentation latency, such as the target latency, reporting interval, or specific events that trigger reporting. Media-aware application 210 sends a start of playback indication to media session handler 230 (332) in response to a user request or automated trigger.

Media session handler 230 initiates streaming session setup with media player 240 (334). Media session handler 230 then acquires service access information from media application function 270 (336). The service access information provides the credentials and network addresses used to access the media content. Subsequently, the streaming session is established (338). Media player 240 sets up a media playback pipeline with media application server 280 (340).

Media session handler 230 enables client data collection and in-band reporting at media player 240 (342). This step activates the logic within media player 240 to measure presentation latency using producer reference times included in the media data and to report the measured presentation latency to media application server 280. Media player 240 sends a confirmation of the client data in-band collection and reporting configuration to media session handler 230 (344).

Media-aware application 210 sends a start of playback indication to media session handler 230 (332) in response to a user request or automated trigger, for example, via an M7d interface. Media session handler 230 initiates streaming session setup with media player 240 (334), for example, via an M11d interface. Media session handler 230 then acquires service access information from media application function 270 (336) via an M5d interface. The service access information provides the credentials and network addresses used to access the media content. Subsequently, the streaming session is established (338) via the M11d interface. Media player 240 sets up a media playback pipeline with media application server 280 (340). Media session handler 230 enables client data collection and in-band reporting at media player 240 (342) via the M11d interface. This step activates the logic within media player 240 to measure presentation latency using producer reference times included in the media data and to report the measured presentation latency to media application server 280. Media player 240 sends a confirmation of the client data in-band collection and reporting configuration to media session handler 230 (344) via the M11d interface.

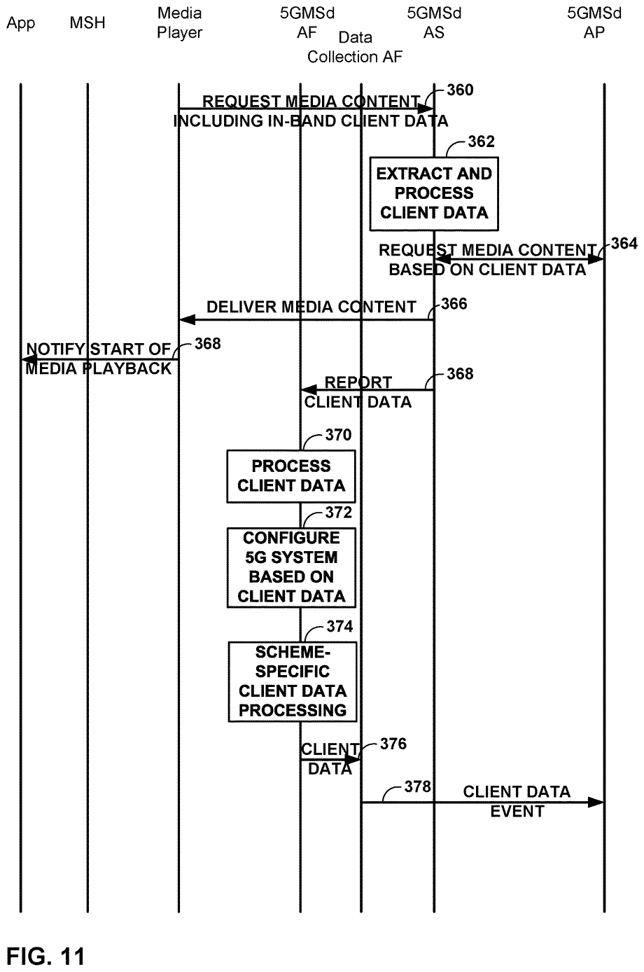

FIG. 11 is a flow diagram illustrating an example process for sending media data and reporting latency metrics per techniques of this disclosure. This process involves interactions between media player 240, media session handler 230, media application server 280, media application function 270 (which may include data collection application function 272), and media application provider 290.

Media player 240 requests media content from media application server 280 (360). This request includes in-band client data, such as measured presentation latency or derived latency information (e.g., a latency delta). Media player 240 may insert this data into an HTTP header or a query parameter of the request URL. Media application server 280 extracts and processes the client data (362). For example, media application server 280 may log the latency metrics or use them to make immediate delivery decisions.

Media application server 280 requests the media content from media application provider 290 (364). In some examples, media application server 280 determines which content to request based on the processed client data. Media application provider 290 delivers the requested media content to media application server 280, which then delivers the content to media player 240 (366).

Media player 240 may request media content from media application server 280 (360) via an M4d interface. This request may include in-band client data, such as measured presentation latency or derived latency information (e.g., a latency delta). Media player 240 may insert this data into an HTTP header or a query parameter of the request URL. Media application server 280 extracts and processes the client data (362). For example, media application server 280 may log the latency metrics or use them to make immediate delivery decisions. Media application server 280 may request the media content from media application provider 290 (364) via an M2d interface. In some examples, media application server 280 determines which content to request based on the processed client data. Media application provider 290 delivers the requested media content to media application server 280, which then delivers the content to media player 240 (366) via the M4d interface.

Media player 240 notifies media session handler 230 of the start of media playback (368) via the M11d interface. In some examples, media session handler 230 sends a client data report to data collection application function 272 (370) via an M3d interface. This reporting may occur out-of-band relative to the media stream. This reporting may occur out-of-band relative to the media stream. Data collection application function 272 processes the received client data (372). Based on this data, data collection application function 272 may configure the 5G system (374). For instance, if the reported latency exceeds a threshold, data collection application function 272 may interact with Policy and Charging Function (PCF) 252 to adjust Quality of Service (QoS) parameters for the session.

Furthermore, media application function 270 (or data collection application function 272) may perform scheme-specific client data processing (376) to format the data for exposure. Media application function 270 then sends a client data event notification to a subscribing entity, such as NWDAF 254 or media application provider (378), exposing the latency metrics or related events.

Latency measurement may be initially set up according to the following example:

The Producer Reference Time supplies times corresponding to the production of associated media. This information permits among others to (i) provide media clients with information to enable consumption and production to proceed at equivalent rates, thus avoiding possible buffer overflow or underflow, and (ii) enable measuring and potentially controlling the latency between the production of the media time and the playout.

The Producer Reference Time (‘prft’) as defined in ISO/IEC 14496-12.

The information may be provided inband as part of the Segments in the (‘prft’), in the MPD or both. In the context of the low-latency DASH service offerings, providing information in the MPD is strongly recommended, whereas providing inband information is left to the deployment.

The producer reference time permits the DASH client to control the End-to-End Latency (EEL) or the Encoding+Distribution Latency (EDL), and permits the service provider to provide information to the client to control this value.

If the CMAF Switching Set contains (‘prft’) information and the flags is set to 0 or the flags 8 and 16 are set, then the value of the timestamp in the producer reference time expresses the encoding time in wall-clock time of the corresponding presentation time. If this information is available, then it should be exposed to the MPD by adding a Producer Reference Time element ProducerReferenceTime as follows:
@id is set to a unique value in the context of the Media Presentation
@inband is set to true
@type to encoder for flag set to 0 or not present as this value is the default value.

If the CMAF Switching Set contains (‘prft’) information and flags 8 and 16 are set, then the value of the timestamp in the producer reference time expresses the capture time in wall-clock time of the corresponding presentation time. If this information is available, then it should be exposed to the MPD by adding a Producer Reference Time element ProducerReferenceTime as follows:
@id is set to a unique value in the context of the Media Presentation
@inband is set to true
@type to captured for both, flag 8 and flag 16, being set.

Regardless, whether the inband information is present or not, it is recommended to provide information in the MPD for the @wallclockTime and the @presentationTime.

Assume that a value wall-clock WC is known that corresponds to a presentation time PT, either by the availability of a pair of for ntp_timestamp and media_time as contained in a (‘prft’) as defined in 8.16.5 of ISO/IEC 14496-12 or by other means. Also, it is assumed that the value of the @presentationTimeOffset PTO is known. The MPD packager should act as follows:
derive the wall-clock time WCA that corresponds to the PTO, namely WCA=WC+(PT−PTO)
convert the WCA into the format of a UTCTiming element format present in the MPD
add this UTCTiming element into the Producer Reference Time element ProducerReferenceTime
add the value of PTO to the @presentationTime
add the value of WCA to the @wallclockTime

Note that multiple producer reference time elements may be added, for example one to support measuring End-to-End Latency (EEL) (@type=“captured”) and one to measure Encoding+Distribution Latency (EDL) (@type=“encoder”).

Latency measurement may be performed as follows:

4. For DASH-IF low-latency clients shall compute the presentation latency within each Period based on a wall clock anchor WCA and a presentation time anchor PTA. WCA and PTA are determined as follows:
a. If the ProducerReferenceTime element is present as defined in clause 9.X.4.2, then:
   i. The information of a UTCTiming element contained in this ProducerReferenceTime shall be used for clock synchronization.
   ii. WCA is the value of the @wallClockTime in a format as specified by depending on the scheme of any UTCTiming element contained in this ProducerReferenceTime.
   iii. PTA is the value of the @presentationTime contained in this ProducerReferenceTime minus the value of the @presentationTimeOffset of the corresponding Representation. Note that this value is 0 for the first element, which may be the only element.
   iv. TS is the @timescale of the corresponding Representation.
   v. If the @inband attribute is set to TRUE, then the client should parse the Segments to re-verify the difference of PTA/TS and WCA based on the information in a ‘prft’ box included in Segments.
b. Else
   i. WCA is the value of the PeriodStart, i.e., the sum of MPD@availabilityStartTime and Period@start,
   ii. PTA is the value of the @presentationTimeOffset
c. Then the presentation latency PL of a presentation time PT presented at wall clock time WC in seconds is determined as PL=(WC−WCA)−(PT−PTA)/TS.

5. It shall implement means to support the service description functionality (either in the DASH client signaled through MPD or by the means of an API, precedence is implementation specific). The parameter interpretation is as follows:
a. The client when consuming in live mode, it should play the content within 500 ms tolerance of the target latency taking into account the above computation for latency. However, the client should consider meeting the latency target also by taking into account knowledge of its own capabilities, the network conditions, and any relevant knowledge of past streaming performance. DASH-IF low latency clients should implement the Presentation time target and constraints in clause 10.20.4 of the DVB-DASH specification.
b. If the max latency is set, the service provider indicates the maximum presentation latency in milliseconds. This value indicates a content provider's desire for the content not to be presented if the latency exceeds the maximum latency. A client when consuming in live mode, should not exceed the described max latency and, if it happens, inform the application that this event happens. Examples to maintain the latency may be to switch to lower available bitrates, drop certain media components, or other means to maintain the latency, to the extreme to even terminate the service.
c. If the min latency is set, the client shall not fall below the described min latency.
d. If the playback speed element is present, clients should use these tools to adapt to the target latency but should not exceed the max/min playback rates. DASH-IF low latency clients should implement the catch-up modes in clause 10.20.6 of the DVB-DASH specification.

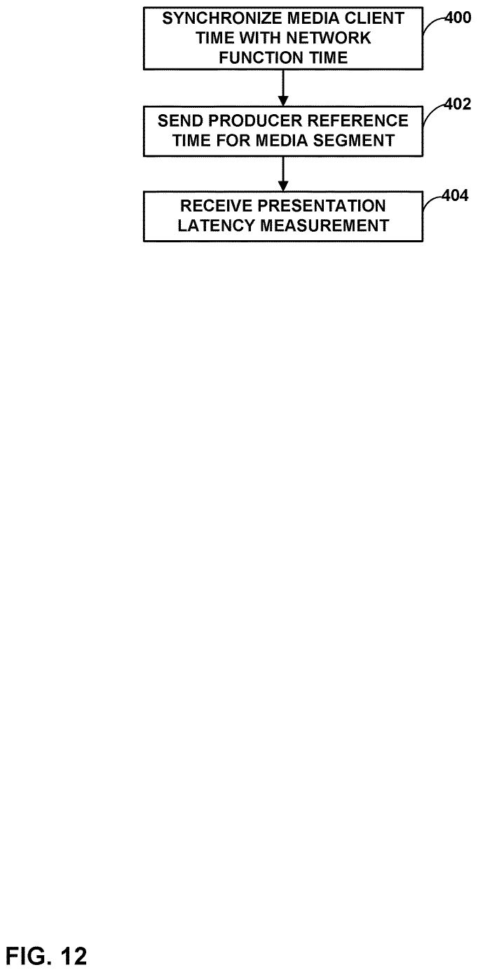

FIG. 12 is a flowchart illustrating an example method of collecting presentation latency measurement data for a media communication session according to techniques of this disclosure. A media collection server device may perform the method of FIG. 12. In some examples, media application function 270 of FIG. 5 performs the method. In other examples, media application server 280, a generic reporting server, or another network entity performs the method.

The media collection server device synchronizes a media client time of a media client with a network function time of a network (400). Synchronizing the times enables the media client to accurately compare a wall-clock time of presentation with a wall-clock time of production. The media collection server device may synchronize the media client time using a coordinated universal time (UTC) time synchronization mechanism, a network clock, or a general system clock.

The media collection server device sends a producer reference time for a media segment of a media presentation to the media client (402). The producer reference time may be represented as a pair comprising a media time and a wall-clock time. In various examples, the producer reference time represents a capture time of the media data, an encoding time of the media data, or a network provider configured time for the media segment. The media collection server device may send the producer reference time in a manifest file or in the media segment. For example, sending the producer reference time may comprise sending the producer reference time in a ProducerReferenceTime (PRFT) box of a CMAF segment including the media segment. Alternatively or additionally, sending the producer reference time may comprise sending the producer reference time in a ProducerReferenceTime element of a Dynamic Adaptive Streaming over HTTP (DASH) Media Presentation Description (MPD). In some examples, the media collection server device sends the producer reference time by sending availability times in a manifest file, from which the media client derives the producer reference time.

The media collection server device receives presentation latency measurement data for media data included in the media segment from the media client (404). The media client may comprise, for example, a dynamic adaptive streaming over HTTP (DASH) client, an HTTP live streaming (HLS) client, or a media client that consumes common media application format (CMAF) segments. The media collection server device may receive the presentation latency measurement data in a DASH metric report, a Common Media Client Data (CMCD) key, or a Quality of Experience (QoE) metric. The media collection server device may receive the presentation latency measurement data in-band as an HTTP header with an HTTP request, in-band as a query parameter of a uniform request locator (URL) of the HTTP request, as a report sent to a dedicated server during a media streaming session for the media presentation, or as a report sent to the dedicated server after the media streaming session. In some examples, the media collection server device further receives derived information including deviation from the presentation latency, an aggregation of presentation latency measurements, or a distribution of presentation latency measurements. The network in which these operations occur may comprise a generic Internet/cloud-based distribution, a 3GPP network, a 5G Media Streaming network, or a broadcast network.

In this manner, the method of FIG. 12 represents an example of a method of collecting presentation latency measurement data for sent media data, including: synchronizing a media client time of a media client with a network function time of a network; sending a producer reference time for a media segment of a media presentation to the media client; and receiving presentation latency measurement data for media data included in the media segment from the media client.

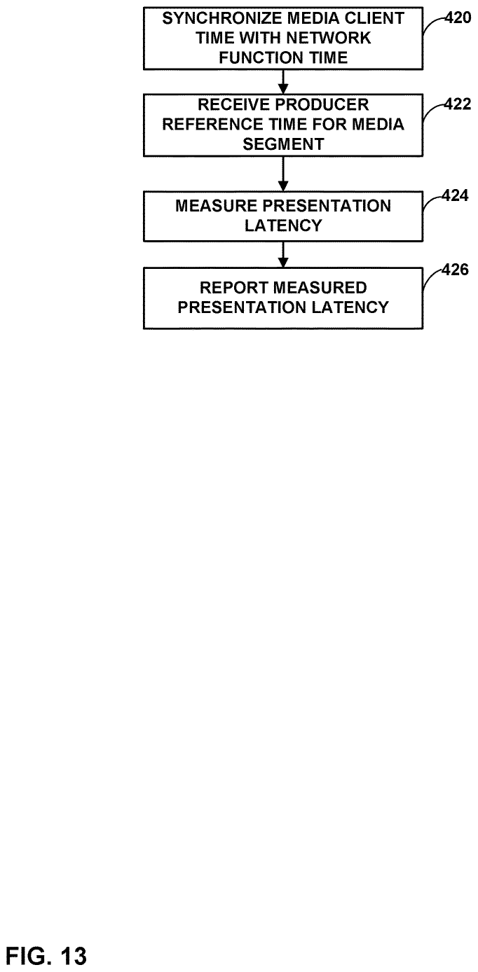

FIG. 13 is a flowchart illustrating an example method of measuring and reporting presentation latency of media data received during a media communication session according to techniques of this disclosure. Media client 220 of UE 202 (FIG. 5) may perform the method of FIG. 13. Initially, media client 220 synchronizes a media client time with a network function time of a network (420). Media client 220 may use one or more of a coordinated universal time (UTC) time synchronization, a network clock, or a general system clock to perform this synchronization.

Media client 220 receives a producer reference time for a media segment of a media presentation (422). The producer reference time generally acts as an anchor for calculating latency. In some examples, the producer reference time may be a {media time, wall-clock time} pair. The producer reference time may represent a capture time of the media data, an encoding time of the media data, or a network provider configured time for the media segment. Media client 220 may receive the producer reference time in a manifest file or in the media segment itself. For instance, media client 220 may receive the producer reference time in a ProducerReferenceTime (PRFT) box of a CMAF segment including the media segment. Alternatively, media client 220 may receive the producer reference time in a ProducerReferenceTime element of a Dynamic Adaptive Streaming over HTTP (DASH) Media Presentation Description (MPD). In other examples, media client 220 derives the producer reference time from availability times signaled in a manifest file.

Media client 220 measures presentation latency of media data included in the media segment using the producer reference time (424). In some examples, media client 220 calculates the presentation latency (MTL) using the formula: MTL=(WC−WCA)−(PT−PTA)/TS. In this formula, MTL represents a media time latency corresponding to the measured presentation latency. WC represents a wall clock time at which media client 220 presents the media segment. WCA represents an anchor wall clock time for the media segment corresponding to the producer reference time. PT corresponds to a presentation duration for the media segment. PTA corresponds to an anchor presentation duration for the media segment. TS represents a timescale representing units of media data per second.

Media client 220 may perform the measurement relative to a start of a predetermined media segment, relative to a start of a previous media segment to the predetermined media segment, or relative to a media segment corresponding to a media time configured for presentation latency measurement. In some examples, media client 220 measures the presentation latency in response to an event, such as the measured presentation latency exceeding a threshold. Furthermore, media client 220 may measure derived information including deviation from the presentation latency, an aggregation of presentation latency measurements, or a distribution of presentation latency measurements.

Media client 220 reports the measured presentation latency of the media data (426). Media client 220 may report the measured presentation latency in a DASH metric report, a Common Media Client Data (CMCD) key, or a Quality of Experience (QoE) metric. Media client 220 may send the report in-band as an HTTP header with an HTTP request or as a query parameter of a uniform request locator (URL) of the HTTP request. Alternatively, media client 220 may send the report to a dedicated server during a media streaming session for the media presentation or after the media streaming session. Media client 220 may determine whether to measure and report the presentation latency based on a playback mode for the media presentation, such as reporting only when in live mode.

The network receiving the report may comprise a generic Internet/cloud-based distribution, a 3GPP network, a 5G Media Streaming network, or a broadcast network. The reporting server device receiving the report may comprise a generic reporting server, a 5GMS application server (AS), a 5GMS application function (AF), or a data collection AF. In some examples, the reporting server device is communicatively coupled to a content steering server. If the measured presentation latency exceeds a threshold, the content steering server may issue instructions to media client 220 to switch to a different server for receiving media data of the media presentation.

In this manner, the method of FIG. 13 represents an example of a method of retrieving media data, including: synchronizing, by a media client, a media client time with a network function time of a network; receiving, by the media client, a producer reference time for a media segment of a media presentation; measuring, by the media client, presentation latency of media data included in the media segment using the producer reference time; and reporting, by the media client, the measured presentation latency of the media data.

The following clauses represent various examples of the techniques of this disclosure:

Clause 1: A method of retrieving media data, the method comprising: synchronizing, by a media client, a media client time with a network function time of a network; receiving, by the media client, a producer reference time for a media segment of a media presentation; measuring, by the media client, presentation latency of media data included in the media segment using the producer reference time; and reporting, by the media client, the measured presentation latency of the media data.

Clause 2: The method of clause 1, wherein measuring the presentation latency of the media data comprises calculating: MTL=(WC−WCA)−(PT−PTA)/TS, wherein MTL comprises a media time latency corresponding to the measured presentation latency of the media data, WC represents a wall clock time at which the media segment is presented, WCA represents an anchor wall clock time for the media segment corresponding to the producer reference time, PT corresponds to a presentation duration for the media segment, PTA corresponds to an anchor presentation duration for the media segment, and TS represents a timescale representing units of media data per second.

Clause 3: The method of any of clauses 1 and 2, wherein the media client comprises one or more of a dynamic adaptive streaming over HTTP (DASH) client, an HTTP live streaming (HLS) client, or a media client that consumes common media application format (CMAF) segments.

Clause 4: The method of any of clauses 1-3, wherein the producer reference time is represented as a {media time, wall-clock time} pair.

Clause 5: The method of any of clauses 1-4, wherein the producer reference time represents at least one of a capture time of the media data, the encoding time of the media data, or a network provider configured time for the media segment.

Clause 6: The method of any of clauses 1-5, wherein synchronizing the media client time with the network function time comprises synchronizing using one or more of a coordinated universal time (UTC) time synchronization, a network clock, or a general system clock.

Clause 7: The method of any of clauses 1-6, wherein receiving the producer reference time comprises receiving the producer reference time in at least one of a manifest file or in the media segment.

Clause 8: The method of any of clauses 1-7, wherein receiving the producer reference time comprises receiving the producer reference time in a ProducerReferenceTime (PRFT) box of a CMAF segment including the media segment.

Clause 9: The method of any of clauses 1-8, wherein receiving the producer reference time comprises receiving the producer reference time in a ProducerReferenceTime element of a Dynamic Adaptive Streaming over HTTP (DASH) Media Presentation Description (MPD).

Clause 10: The method of any of clauses 1-9, wherein receiving the producer reference time comprises deriving the producer reference time from availability times signaled in a manifest file.

Clause 11: The method of any of clauses 1-10, wherein reporting the measured presentation latency comprises reporting the measured presentation latency in one or more of a DASH metric report, a Common Media Client Data (CMCD) key, or a Quality of Experience (QoE) metric.

Clause 12: The method of any of clauses 1-11, wherein reporting the measured presentation latency comprises reporting the measured presentation latency one or more of: in-band as an HTTP header with an HTTP request, in-band as a query parameter of a uniform request locator (URL) of the HTTP request, as a report sent to a dedicated server during a media streaming session for the media presentation, or as a report sent to the dedicated server after the media streaming session.

Clause 13: The method of any of clauses 1-12, wherein measuring and/or reporting the presentation latency of the media data comprises measuring the presentation latency relative to a start of a predetermined media segment, relative to a start of a previous media segment to the predetermined media segment, relative to a media segment corresponding to a media time configured for presentation latency measurement, or in response to an event.

Clause 14: The method of clause 13, wherein the event comprises the measured presentation latency exceeding a threshold.

Clause 15: The method of any of clauses 1-14, further comprising: measuring derived information including one or more of deviation from the presentation latency, an aggregation of presentation latency measurements, or a distribution of presentation latency measurements; and reporting the derived information.

Clause 16: The method of any of clauses 1-15, wherein measuring and reporting the measured presentation latency comprises measuring and reporting the measured presentation latency based on a playback mode for the media presentation.

Clause 17: The method of clause 16, wherein the playback mode comprises live mode.

Clause 18: The method of any of clauses 1-17, wherein the network comprises one or more of a generic Internet/cloud-based distribution, a 3GPP network, a 5G Media Streaming network, or a broadcast network.

Clause 19: The method of any of clauses 1-18, wherein reporting comprises reporting to a reporting server device, the reporting server device comprising one or more of a generic reporting server, a 5GMS application server (AS), a 5GMS application function (AF), or a data collection AF.

Clause 20: The method of clause 19, wherein the reporting server device is communicatively coupled to a content steering server, the method further comprising receiving instructions from the content steering server to switch to a different server for receiving media data of the media presentation in response to the measured presentation latency exceeding a threshold.

Clause 21: A method of collecting presentation latency measurement data for sent media data, the method comprising: synchronizing a media client time of a media client with a network function time of a network; sending a producer reference time for a media segment of a media presentation to the media client; and receiving presentation latency measurement data for media data included in the media segment from the media client.

Clause 22: The method of clause 21, wherein the media client comprises one or more of a dynamic adaptive streaming over HTTP (DASH) client, an HTTP live streaming (HLS) client, or a media client that consumes common media application format (CMAF) segments.

Clause 23: The method of any of clauses 21 and 22, wherein the producer reference time is represented as a {media time, wall-clock time} pair.

Clause 24: The method of any of clauses 21-23, wherein the producer reference time represents at least one of a capture time of the media data, the encoding time of the media data, or a network provider configured time for the media segment.

Clause 25: The method of any of clauses 21-24, wherein synchronizing the media client time with the network function time comprises synchronizing using one or more of a coordinated universal time (UTC) time synchronization, a network clock, or a general system clock.

Clause 26: The method of any of clauses 21-25, wherein sending the producer reference time comprises sending the producer reference time in at least one of a manifest file or in the media segment.

Clause 27: The method of any of clauses 21-26, wherein sending the producer reference time comprises sending the producer reference time in a ProducerReferenceTime (PRFT) box of a CMAF segment including the media segment.

Clause 28: The method of any of clauses 21-27, wherein sending the producer reference time comprises sending the producer reference time in a ProducerReferenceTime element of a Dynamic Adaptive Streaming over HTTP (DASH) Media Presentation Description (MPD).

Clause 29: The method of any of clauses 21-28, wherein sending the producer reference time comprises sending availability times in a manifest file.

Clause 30: The method of any of clauses 21-29, wherein receiving the presentation latency measurement data comprises receiving the presentation latency measurement data in one or more of a DASH metric report, a Common Media Client Data (CMCD) key, or a Quality of Experience (QoE) metric.

Clause 31: The method of any of clauses 21-30, wherein receiving the presentation latency measurement data comprises receiving the presentation latency measurement data one or more of: in-band as an HTTP header with an HTTP request, in-band as a query parameter of a uniform request locator (URL) of the HTTP request, as a report sent to a dedicated server during a media streaming session for the media presentation, or as a report sent to the dedicated server after the media streaming session.

Clause 32: The method of any of clauses 21-31, further comprising receiving derived information including one or more of deviation from the presentation latency, an aggregation of presentation latency measurements, or a distribution of presentation latency measurements.

Clause 33: The method of any of clauses 21-32, wherein the network comprises one or more of a generic Internet/cloud-based distribution, a 3GPP network, a 5G Media Streaming network, or a broadcast network.

Clause 34: A device for exchanging presentation latency data for media data, the device comprising one or more means for performing the method of any of clauses 1-33.

Clause 35: The device of clause 34, wherein the one or more means comprise a memory configured to store media data and a processing system implemented in circuitry.

Clause 36: The device of clause 34, wherein the device comprises at least one of: an integrated circuit; a microprocessor; and a wireless communication device.

Clause 37: A device for retrieving media data, the device comprising: means for synchronizing a media client time with a network function time of a network; means for receiving a producer reference time for a media segment of a media presentation; means for measuring presentation latency of media data included in the media segment using the producer reference time; and means for reporting the measured presentation latency of the media data.

Clause 38: A device for collecting presentation latency measurement data for sent media data, the device comprising: means for synchronizing a media client time of a media client with a network function time of a network; means for sending a producer reference time for a media segment of a media presentation to the media client; and means for receiving presentation latency measurement data for media data included in the media segment from the media client.

Clause 39: A computer-readable storage medium having stored thereon instructions that, when executed, cause a processor to perform the method of any of clauses 1-33.

Clause 40: A method of retrieving media data, the method comprising: synchronizing, by a media client, a media client time with a network function time of a network; receiving, by the media client, a producer reference time for a media segment of a media presentation; measuring, by the media client, presentation latency of media data included in the media segment using the producer reference time; and reporting, by the media client, the measured presentation latency of the media data.

Clause 41: The method of clause 40, wherein measuring the presentation latency of the media data comprises calculating: MTL=(WC−WCA)−(PT−PTA)/TS, wherein MTL comprises a media time latency corresponding to the measured presentation latency of the media data, WC represents a wall clock time at which the media segment is presented, WCA represents an anchor wall clock time for the media segment corresponding to the producer reference time, PT corresponds to a presentation duration for the media segment, PTA corresponds to an anchor presentation duration for the media segment, and TS represents a timescale representing units of media data per second.

Clause 42: The method of any of clauses 40 and 41, wherein the media client comprises one or more of a dynamic adaptive streaming over HTTP (DASH) client, an HTTP live streaming (HLS) client, or a media client that consumes common media application format (CMAF) segments.

Clause 43: The method of any of clauses 40-42, wherein the producer reference time is represented as a {media time, wall-clock time} pair.

Clause 44: The method of any of clauses 40-43, wherein the producer reference time represents at least one of a capture time of the media data, the encoding time of the media data, or a network provider configured time for the media segment.

Clause 45: The method of any of clauses 40-44, wherein synchronizing the media client time with the network function time comprises synchronizing using one or more of a coordinated universal time (UTC) time synchronization, a network clock, or a general system clock.

Clause 46: The method of any of clauses 40-45, wherein receiving the producer reference time comprises receiving the producer reference time in at least one of a manifest file or in the media segment.

Clause 47: The method of any of clauses 40-46, wherein receiving the producer reference time comprises receiving the producer reference time in a ProducerReferenceTime (PRFT) box of a CMAF segment including the media segment.

Clause 48: The method of any of clauses 40-47, wherein receiving the producer reference time comprises receiving the producer reference time in a ProducerReferenceTime element of a Dynamic Adaptive Streaming over HTTP (DASH) Media Presentation Description (MPD).

Clause 49: The method of any of clauses 40-48, wherein receiving the producer reference time comprises deriving the producer reference time from availability times signaled in a manifest file.

Clause 50: The method of any of clauses 40-49, wherein reporting the measured presentation latency comprises reporting the measured presentation latency in one or more of a DASH metric report, a Common Media Client Data (CMCD) key, or a Quality of Experience (QoE) metric.

Clause 51: The method of any of clauses 40-50, wherein reporting the measured presentation latency comprises reporting the measured presentation latency one or more of: in-band as an HTTP header with an HTTP request, in-band as a query parameter of a uniform request locator (URL) of the HTTP request, as a report sent to a dedicated server during a media streaming session for the media presentation, or as a report sent to the dedicated server after the media streaming session.

Clause 52: The method of any of clauses 40-51, wherein measuring the presentation latency of the media data comprises measuring the presentation latency relative to a start of a predetermined media segment, relative to a start of a previous media segment to the predetermined media segment, or relative to a media segment corresponding to a media time configured for presentation latency measurement, or in response to an event.

Clause 53: The method of any of clauses 40-52, wherein measuring the presentation latency of the media data comprises measuring the presentation latency in response to an event, the method further comprising reporting the measured presentation latency when the measured presentation latency exceeds a threshold.

Clause 54: The method of any of clauses 40-53, further comprising: measuring derived information including one or more of deviation from the presentation latency, an aggregation of presentation latency measurements, or a distribution of presentation latency measurements; and reporting the derived information.

Clause 55: The method of any of clauses 40-54, wherein measuring and reporting the measured presentation latency comprises measuring and reporting the measured presentation latency based on a playback mode for the media presentation.

Clause 56: The method of any of clauses 40-55, wherein the network comprises one or more of a generic Internet/cloud-based distribution, a 3GPP network, a 5G Media Streaming network, or a broadcast network.

Clause 57: The method of any of clauses 40-56, wherein reporting comprises reporting to a reporting server device, the reporting server device comprising one or more of a generic reporting server, a 5GMS application server (AS), a 5GMS application function (AF), or a data collection AF.

Clause 58: The method of clause 57, wherein the reporting server device is communicatively coupled to a content steering server, the method further comprising receiving instructions from the content steering server to switch to a different server for receiving media data of the media presentation in response to the measured presentation latency exceeding a threshold.

Clause 59: A media client device for retrieving media data, the device comprising: a memory configured to store media data; and a processing system implemented in circuitry and configured to: synchronize a media client time with a network function time of a network; receive a producer reference time for a media segment of a media presentation; measure presentation latency of media data included in the media segment using the producer reference time; and report the measured presentation latency of the media data.

Clause 60: A method of collecting presentation latency measurement data for sent media data, the method comprising: synchronizing a media client time of a media client with a network function time of a network; sending a producer reference time for a media segment of a media presentation to the media client; and receiving presentation latency measurement data for media data included in the media segment from the media client.

Clause 61: The method of clause 60, wherein the media client comprises one or more of a dynamic adaptive streaming over HTTP (DASH) client, an HTTP live streaming (HLS) client, or a media client that consumes common media application format (CMAF) segments.

Clause 62: The method of any of clauses 60 and 61, wherein the producer reference time is represented as a {media time, wall-clock time} pair.

Clause 63: The method of any of clauses 60-62, wherein the producer reference time represents at least one of a capture time of the media data, the encoding time of the media data, or a network provider configured time for the media segment.

Clause 64: The method of any of clauses 60-63, wherein synchronizing the media client time with the network function time comprises synchronizing using one or more of a coordinated universal time (UTC) time synchronization, a network clock, or a general system clock.

Clause 65: The method of any of clauses 60-64, wherein sending the producer reference time comprises sending the producer reference time in at least one of a manifest file or in the media segment.

Clause 66: The method of any of clauses 60-65, wherein sending the producer reference time comprises sending the producer reference time in a ProducerReferenceTime (PRFT) box of a CMAF segment including the media segment.

Clause 67: The method of any of clauses 60-66, wherein sending the producer reference time comprises sending the producer reference time in a ProducerReferenceTime element of a Dynamic Adaptive Streaming over HTTP (DASH) Media Presentation Description (MPD).

Clause 68: The method of any of clauses 60-67, wherein sending the producer reference time comprises sending availability times in a manifest file.

Clause 69: The method of any of clauses 60-68, wherein receiving the presentation latency measurement data comprises receiving the presentation latency measurement data in one or more of a DASH metric report, a Common Media Client Data (CMCD) key, or a Quality of Experience (QoE) metric.

Clause 70: The method of any of clauses 60-69, wherein receiving the presentation latency measurement data comprises receiving the presentation latency measurement data one or more of: in-band as an HTTP header with an HTTP request, in-band as a query parameter of a uniform request locator (URL) of the HTTP request, as a report sent to a dedicated server during a media streaming session for the media presentation, or as a report sent to the dedicated server after the media streaming session.

Clause 71: The method of any of clauses 60-70, further comprising receiving derived information including one or more of deviation from the presentation latency, an aggregation of presentation latency measurements, or a distribution of presentation latency measurements.

Clause 72: The method of any of clauses 60-71, wherein the network comprises one or more of a generic Internet/cloud-based distribution, a 3GPP network, a 5G Media Streaming network, or a broadcast network.

Clause 73: A media collection server device, the media collection server device comprising: a memory configured to store media data; and a processing system implemented in circuitry and configured to: synchronize a media client time of a media client with a network function time of a network; send a producer reference time for a media segment of a media presentation to the media client; and receive presentation latency measurement data for media data included in the media segment from the media client.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of retrieving media data, the method comprising:
synchronizing, by a media client, a media client time with a network function time of a network;
receiving, by the media client, a producer reference time for a media segment of a media presentation;
measuring, by the media client, presentation latency of media data included in the media segment using the producer reference time to form measured presentation latency; and
reporting, by the media client, the measured presentation latency of the media data.

2. The method of claim 1, wherein measuring the presentation latency of the media data comprises calculating: MTL=(WC−WCA)−(PT−PTA)/TS,
wherein MTL comprises a media time latency corresponding to the measured presentation latency of the media data, WC represents a wall clock time at which the media segment is presented, WCA represents an anchor wall clock time for the media segment corresponding to the producer reference time, PT corresponds to a presentation duration for the media segment, PTA corresponds to an anchor presentation duration for the media segment, and TS represents a timescale representing units of media data per second.

3. The method of claim 1, wherein the media client comprises one or more of a dynamic adaptive streaming over HTTP (DASH) client, an HTTP live streaming (HLS) client, or a media client that consumes common media application format (CMAF) segments.

4. The method of claim 1, wherein the producer reference time is represented as a {media time, wall-clock time} pair.

5. The method of claim 1, wherein the producer reference time represents at least one of a capture time of the media data, an encoding time of the media data, or a network provider configured time for the media segment.

6. The method of claim 1, wherein synchronizing the media client time with the network function time comprises synchronizing using one or more of a coordinated universal time (UTC) time synchronization, a network clock, or a general system clock.

7. The method of claim 1, wherein receiving the producer reference time comprises receiving the producer reference time in at least one of a manifest file or in the media segment.

8. The method of claim 1, wherein receiving the producer reference time comprises receiving the producer reference time in a ProducerReferenceTime (PRFT) box of a CMAF segment including the media segment.

9. The method of claim 1, wherein receiving the producer reference time comprises receiving the producer reference time in a ProducerReferenceTime element of a Dynamic Adaptive Streaming over HTTP (DASH) Media Presentation Description (MPD).

10. The method of claim 1, wherein receiving the producer reference time comprises deriving the producer reference time from availability times signaled in a manifest file.

11. The method of claim 1, wherein reporting the measured presentation latency comprises reporting the measured presentation latency in one or more of a Dynamic Adaptive Streaming over HTTP (DASH) metric report, a Common Media Client Data (CMCD) key, or a Quality of Experience (QoE) metric.

12. The method of claim 1, wherein reporting the measured presentation latency comprises reporting the measured presentation latency one or more of: in-band as an HTTP header with an HTTP request, in-band as a query parameter of a uniform request locator (URL) of the HTTP request, as a report sent to a dedicated server during a media streaming session for the media presentation, or as a report sent to the dedicated server after the media streaming session.

13. The method of claim 1, wherein measuring the presentation latency of the media data comprises measuring the presentation latency relative to a start of a predetermined media segment, relative to a start of a previous media segment to the predetermined media segment, or relative to a media segment corresponding to a media time configured for presentation latency measurement, or in response to an event.

14. The method of claim 1, wherein measuring the presentation latency of the media data comprises measuring the presentation latency in response to an event, the method further comprising reporting the measured presentation latency when the measured presentation latency exceeds a threshold.

15. The method of claim 1, further comprising:
measuring derived information including one or more of deviation from the presentation latency, an aggregation of presentation latency measurements, or a distribution of presentation latency measurements; and
reporting the derived information.

16. The method of claim 1, wherein measuring the presentation latency and reporting the measured presentation latency comprises measuring the presentation latency and reporting the measured presentation latency based on a playback mode for the media presentation.

17. The method of claim 1, wherein the network comprises one or more of a generic Internet/cloud-based distribution, a 3GPP network, a 5G Media Streaming network, or a broadcast network.

18. The method of claim 1, wherein reporting comprises reporting to a reporting server device, the reporting server device comprising one or more of a generic reporting server, a 5GMS application server (AS), a 5GMS application function (AF), or a data collection AF.

19. The method of claim 18, wherein the reporting server device is communicatively coupled to a content steering server, the method further comprising receiving instructions from the content steering server to switch to a different server for receiving media data of the media presentation in response to the measured presentation latency exceeding a threshold.

20. A media client device for retrieving media data, the device comprising:
a memory configured to store media data; and
a processing system implemented in circuitry and configured to:
synchronize a media client time with a network function time of a network;
receive a producer reference time for a media segment of a media presentation;
measure presentation latency of media data included in the media segment using the producer reference time to form measured presentation latency; and
report the measured presentation latency of the media data.

21. A method of collecting presentation latency measurement data for sent media data, the method comprising:
synchronizing a media client time of a media client with a network function time of a network;
sending a producer reference time for a media segment of a media presentation to the media client; and
receiving presentation latency measurement data for media data included in the media segment from the media client.

22. The method of claim 21, wherein the media client comprises one or more of a dynamic adaptive streaming over HTTP (DASH) client, an HTTP live streaming (HLS) client, or a media client that consumes common media application format (CMAF) segments.

23. The method of claim 21, wherein the producer reference time is represented as a {media time, wall-clock time} pair.

24. The method of claim 21, wherein the producer reference time represents at least one of a capture time of the media data, an encoding time of the media data, or a network provider configured time for the media segment.

25. The method of claim 21, wherein synchronizing the media client time with the network function time comprises synchronizing using one or more of a coordinated universal time (UTC) time synchronization, a network clock, or a general system clock.

26. The method of claim 21, wherein sending the producer reference time comprises sending the producer reference time in at least one of a manifest file, in a ProducerReferenceTime (PRFT) box of a CMAF segment including the media segment, or in a ProducerReferenceTime element of a Dynamic Adaptive Streaming over HTTP (DASH) Media Presentation Description (MPD).

27. The method of claim 21, wherein receiving the presentation latency measurement data comprises receiving the presentation latency measurement data in one or more of a DASH metric report, a Common Media Client Data (CMCD) key, or a Quality of Experience (QoE) metric.

28. The method of claim 21, wherein receiving the presentation latency measurement data comprises receiving the presentation latency measurement data one or more of: in-band as an HTTP header with an HTTP request, in-band as a query parameter of a uniform request locator (URL) of the HTTP request, as a report sent to a dedicated server during a media streaming session for the media presentation, or as a report sent to the dedicated server after the media streaming session.

29. The method of claim 21, further comprising receiving derived information including one or more of deviation from the presentation latency measurement data, an aggregation of presentation latency measurements, or a distribution of presentation latency measurements.

30. A media collection server device, the media collection server device comprising:
a memory configured to store media data; and
a processing system implemented in circuitry and configured to:
synchronize a media client time of a media client with a network function time of a network;
send a producer reference time for a media segment of a media presentation to the media client; and
receive presentation latency measurement data for media data included in the media segment from the media client.
